(19) United States
(12) Patent Application Publication
(10) Pub. No.: US 2016/0025563 A1
(43) Pub. Date: Jan. 28, 2016

(54) Photonic Optical Sensor and Method of Use Thereof

(71) Applicant: Idaho State University, Pocatello, ID (US)

(72) Inventor: Eric A. Burgett, Pocatello, ID (US)

(21) Appl. No.: 14/808,896

(22) Filed: Jul. 24, 2015

Related U.S. Application Data
(60) Provisional application No. 62/028,725, filed on Jul. 24, 2014.

(51) Int. Cl. G01J 3/02; G01K 11/32; G01L 1/24

(52) U.S. Cl. CPC G01J 3/0218; G01L 1/246; G01K 11/3206

(57) ABSTRACT

The system may include a photonic optical sensor including a photonic crystal and an incident light source arranged so as to project light onto the photonic optical sensor, and such that the photonic optical sensor returns a portion of the light projected onto the photonic optical sensor as returned light. The system may further include a detector positioned with respect to the photonic optical sensor so as to detect the returned light. The detector produces a data output based on the returned light. Additionally, a processing unit receives and processes the data output.

### TECHNICAL FIELD

This application relates generally to a photonic crystal as an optical sensor. More specifically, it relates to a photonic crystal formed in or on a workpiece or other substrate and the apparatus used to implement the photonic crystal as an optical sensor. Further, the method of use of a photonic crystal is described herein.

### BACKGROUND

Many industrial processes and operations require sensors to translate mechanical properties of materials used in the processes and operations into electrical signals for data acquisition, analysis, or storage. The signals are processed into quantifiable and usable data. The data obtained by the sensor may be used to monitor and record behavioral characteristics for study, research, or to provide feedback to mechanical or industrial systems. More specifically, the data provides the person who implements the processes and operations with technical information about the potential limits and capabilities of the materials involved. With this information, the person is able to modify, improve, and manipulate the processes and operations to achieve better results and avoid failure. These mechanical properties, may be, for example, stress or strain capabilities of the materials.

Typically, solid-state sensors are used to examine and measure bending and twisting of a substrate or physical structure (beam, bar sheet, film, or the like) through quantification of electrical changes. These electrical changes may include current or voltage levels associated with the deformation of a stimulated piezo-resistive sense-element. As with many low-level electrical signals, such as those found in solid-state sensors, stray electromagnetic fields such as, for example, electromagnetic interference, electromagnetic radiation, charged particle radiation, or electrical noise, may interfere with the electrical signals. Such stray fields corrupt solid-state or hard-wired sensors. In turn, noise detected by the sensors may render obtained measurements ambiguous or unstable, providing an inefficient, and to some extent inaccurate, method of monitoring and recording system and material characteristics. In addition, the application of a low-voltage signal requires physical connection to both a power supply and the corresponding sensor element, which is not typically located on a workpiece being examined. However, this connection to a power supply and the workpiece limits the applications and environments in which low-voltage signal sensors can be implemented. For example, some environments may be corrosive or involve extreme conditions whereby sensors may not function appropriately. Additionally, sensors may be located on moving objects where connection to a power supply and sensor element are impractical.

Furthermore, measurements deduced from solid-state sensors may be distorted by variances in temperature, properties of the adhesive or connection means used to attach the sensor to the workpiece, and the material properties of the workpiece. Consequently, solid-state sensors represent an unreliable method for measuring and sensing the mechanical properties of industrial processes and operations.

### SUMMARY

The system according to the instant application may include a photonic optical sensor including a photonic crystal and an incident light source arranged so as to project light onto the photonic optical sensor, and such that the photonic optical sensor returns a portion of the light projected onto the photonic optical sensor as returned light. The system may further include a detector positioned with respect to the photonic optical sensor so as to detect the returned light. The detector produces a data output based on the returned light. Additionally, a processing unit receives and processes the data output.

A method according to an embodiment of the instant application may include the steps of applying a masking layer onto a workpiece; and forming a photonic crystal onto the workpiece in the masking layer.

A method of measuring and detecting a mechanical property according to an embodiment of the instant application may include forming a photonic optical sensor onto a workpiece. Further, a light source may be projected onto the photonic optical sensor, and the returned light from the photonic optical sensor may be detected.

### BRIEF DESCRIPTION OF THE DRAWINGS

The Detailed Description is set forth with reference to the accompanying figures. The accompanying drawings, which are incorporated in and constitute a part of this disclosure, illustrate embodiments and together with the description, serve to explain the principles of the subject of the instant application. In the figures, the left-most digit(s) of a reference number identifies the figure in which the reference number first appears. The use of the same reference numbers in different figures indicates similar or identical items. It is noted that the patent or patent application file contains at least one drawing executed in color. Copies of this patent or patent application publication with color drawing(s) will be provided by the Office upon request and payment of the necessary fee.

FIG. 1 illustrates a microphotograph of a photonic crystal having a pattern of optical elements, an illustration of projected light, and a corresponding shift in wavelength of the light provided by the photonic crystal.

FIG. 2 illustrates a schematic representation of a photonic optical sensor system.

FIG. 3 illustrates a plot of the returned wavelength versus the temperature of a photonic crystal formed in silicon.

FIG. 4 illustrates a top view microphotograph of a photonic crystal formed in steel with a 6×6 element lattice.

FIG. 5 illustrates a microphotograph of the photonic crystal of FIG. 4 viewed at a 45° angle.

FIG. 6 illustrates a top view microphotograph of a photonic crystal formed in steel with a plurality of 10×10 element lattices arranged in a 4×4 array.

FIG. 7 illustrates a microphotograph of the photonic crystal of FIG. 6 with side lighting at a first angle to observe a photonic effect with intensity in the red.

FIG. 8 illustrates a microphotograph of the photonic crystal of FIG. 6 with side lighting at a second angle to observe a photonic effect with intensity in the green.

FIG. 9 illustrates a microphotograph of the photonic crystal of FIG. 6 with side lighting at a third angle to observe a photonic effect with intensity in the blue.

FIG. 10 illustrates microphotographs of a 1-D photonic crystal (Bragg grating) formed on steel.

FIG. 11 illustrates a microphotograph of a photonic crystal formed on steel with a plurality of 10×10 element lattices arranged in a 10×10 array.

FIG. 12 illustrates a plot of the returned light from the photonic crystal of FIG. 11.

FIG. 13 illustrates a grouping of fiber optic cables used to measure the returned light from the photonic optical sensor.

FIG. 14 illustrates microphotographs of a photonic crystal formed in zircaloy-4 with a plurality of 10×10 element lattices arranged in a 2×2 photonic crystal array with side angle illuminations having intensities in the red and blue.

FIG. 15 illustrates a photograph of a shale sample subjected to a mechanical indenter with a photonic optical sensor.

FIG. 16 illustrates a stress/strain plot of the shale sample of FIG. 15, determined with a mechanical indenter with a photonic optical sensor.

FIG. 17 illustrates a cross-sectional view of a photonic sensor fabricated using a masking layer.

FIG. 18 illustrates a microphotographs of a 2-D photonic crystal (Bragg grating) formed on steel.

### DETAILED DESCRIPTION

### Overview

This disclosure is directed to a system and method that may be used to etch and form a photonic optical crystal onto a workpiece or material and to monitor data or information for an industrial process or operation through the application of a photonic optical sensor. The embodiments are described with specificity in order to meet statutory requirements. However, the description itself is not intended to limit the scope of this patent. Rather, the inventors have contemplated that the present application might also be embodied in other ways, to include different elements or combinations of elements similar to the ones described in this document, in conjunction with other present or future technologies.

The method of monitoring an industrial process or a workpiece described herein may generally be performed using a sensor system that utilizes a photonic crystal as a photonic optical sensor. The sensor system may include a photonic optical sensor formed on a workpiece and a source of light for projection onto the photonic optical sensor such that at least a portion of the projected light may be transformed by the photonic optical sensor. The photonic optical sensor may include a geometric pattern of optical elements formed on a surface of the workpiece.

The embodiments and methods described herein allow for high resolution of material property measurements, orders of magnitude greater than existing technology, and may allow for the photonic optical sensor to be applied in situ to the material or workpiece desired. The process of fabricating the photonic optical sensor on the workpiece therefore may allow for the strategic placement and application of the photonic optical sensor to materials previously unavailable.

By forming a photonic optical sensor directly onto a workpiece, the sensor may be specifically designed for given material properties of the workpiece. The positioning of two or more sensors in series along a workpiece may identify and measure positional forces that are applied to a work piece.

In addition, the workpiece may expand from an increase in temperature and the shape of the photonic crystal will be altered, therein causing a shift in wavelength of light correlated with the material's temperature. Therefore, thermal data of the workpiece may be determined using a material's coefficient of thermal expansion.

The transformation of the projected light signifies a change or shift in wavelength of the projected light. A detector may then be used to process at least a portion of transformed light into an electrical signal. As such, the sensor need not convert the light into an electrical signal. In a similar example, a thermochromic sensor, which changes color based on temperature, employs a non-electrical signal conversion technology.

A processing unit may then convert and analyze the electrical signal output in order to provide data information related to an industrial process. For example, this information may include determining mechanical or thermal properties of the workpiece. Accordingly, the change or shift in wavelength may be correlated to a selected mechanical or thermal property of the workpiece.

Workpieces may be fabricated from metal, metal alloys, ceramics, plastics, or other composite materials. Alternatively, photonic optical crystals may be formed in other substrates, such as silicon. While the sensing system may find applications in numerous fields, some examples include: power generation, including a reactor environment (e.g., in-core, in-cladding, in-fuel pellet, etc.); mass transportation vehicles and infrastructure; chemical and semiconductor manufacturing; mining; oil and gas recovery; and aerospace including jet engine systems and components, aviation structural components, and hydraulic systems. Through the direct application of the sensor into the material, and from the material, the sensor may be as durable as the material providing the corrosion resistance.

### Detailed Explanation of the Components in the Figures

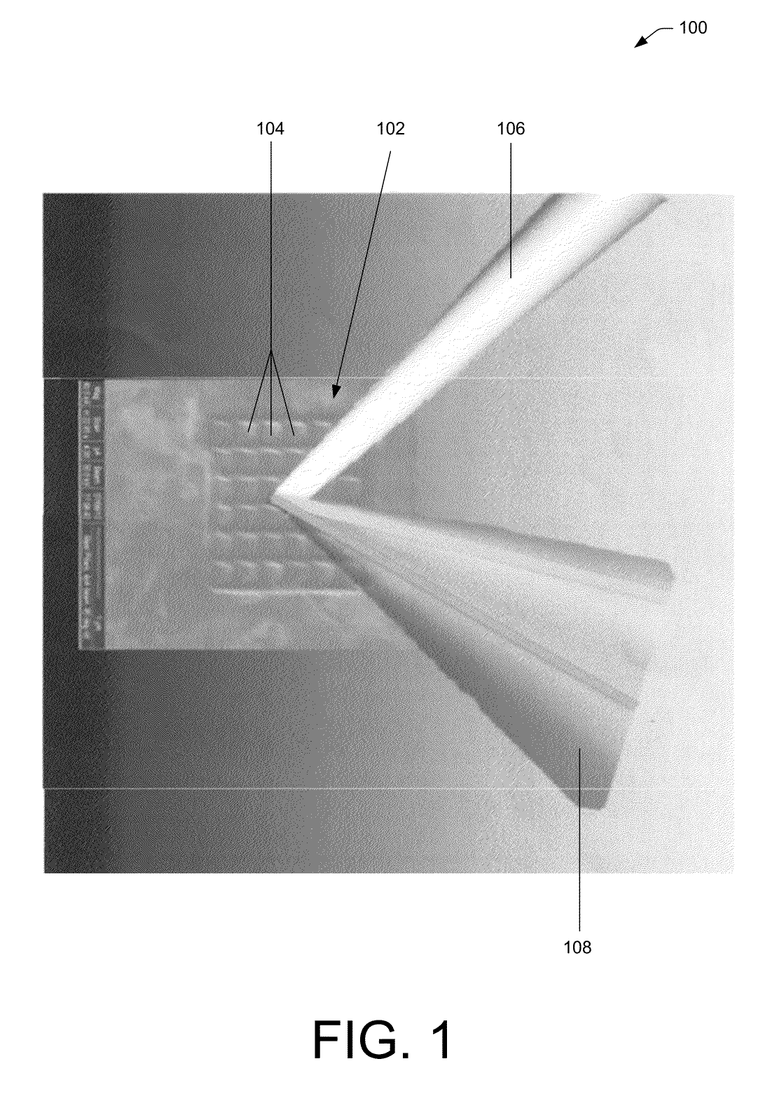

As shown in illustration 100 of FIG. 1, a nano-structured photonic crystal 102 formed of silicon may include a plurality of optical elements 104. The photonic crystal 102 may be tuned such that, when an incident light source 106 is projected onto the photonic crystal 102, the photonic crystal 102 selectively reflects a particular wavelength of light 108. (Note that color drawings have been provided to the US Patent and Trademark Office with this application to ensure a better understanding of the technology.) The optical elements 104 may be formed in various shapes. Correspondingly, a change in the shape of the optical elements 104 (e.g., element pattern) may result in detectable changes in the wavelength of the projected light. The optical elements 104, described in more detail herein, make up the structure of the photonic crystal. The optical elements 104 require a difference in index of refraction compared to that of the material of the workpiece, but need not be transparent or translucent. Accordingly, the optical elements may only contain a different set of dielectric constants or indices of refraction. Therefore, the optical elements 104 may be designed to detect certain changes in a property of a workpiece. In an embodiment, strain in a metal such as steel or a steel alloy may be detected in real-time by analyzing the wavelength of the returned light from the photonic crystal. For example, a 0.01% strain in a honeycomb pattern may produce a total band gap shift of about 5 nm, which may be measured with a spectrophotometer.

The band gap refers to the electromagnetic (optical, near optical, infrared, ultraviolet, microwave, x-ray, or the like) wave energy in which the wave is the forbidden energy range and cannot be transmitted through the material. In this representation of the technology, the application may tailor a pattern and periodicity of high and low dielectric constant materials through a series of holes, rods, squares, or the like in square, triangle or hexagonal arrays to manipulate the response to the desired sensitivity.

Tuning of a photonic sensor may register a 1×10⁻⁹ change in strain, resulting in a 2 nm shift in the total band gap. Through specific tuning of multiple band gaps, 9 or more orders of magnitude of strain, force, or temperature may be measured. Such alterations allow for the extinction of higher order bands, providing high resolution and lower order band gaps covering a significantly larger dynamic range. The actual wavelength shifts may be simulated using an MIT Photonic Band (MPB) package.

The optical elements 104 may be used as an in-situ, real-time, durable, and multifunctional system that may offer considerable insight into the performance of structures, systems, and components in a variety of operating environments, including harsh and corrosive environments, and those with high ionizing radiation. The optical nature of the sensor system may allow for potentially sensitive electronics to be coupled to a detector with fiber optics, thereby placing them outside the operating environment.

If a full band gap is present, a single photonic crystal 102 located on the workpiece may be used to simultaneously measure physical characteristics, such as stress, strain, and temperature. However, the detected results may be convolved and therefore may require analysis into one or more specific wavelength frequency regions for each of the signals.

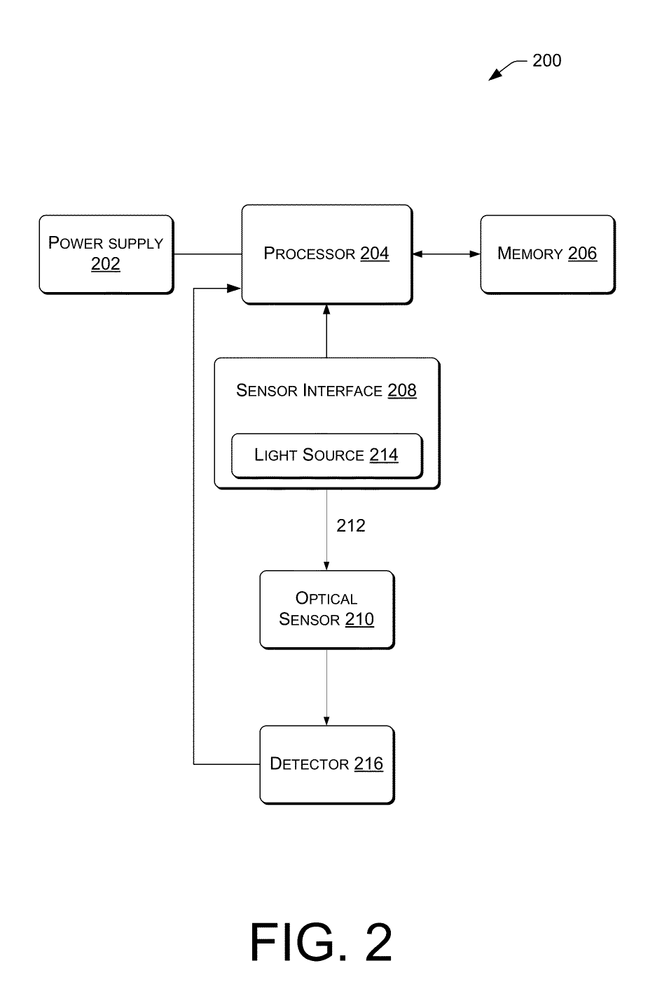

FIG. 2 illustrates an embodiment according to the instant application of an electronics module 200, which may be configured to perform a variety of functions. Electronics module 200 may include a power supply 202, a processor 204, and memory 206. Furthermore, electronics module 200 may include a sensor interface 208 coupled to each of one or more photonic optical sensor(s) 210 via an optical cable 212. Sensor interface 208 may include a light source 214, such as a laser, and appropriate equipment for delivery of a light to the 1-D or 2-D photonic crystals. Light source 214 may include a light source with a known and controllable frequency. It should be noted that each light source 214 may be operably coupled to one or more photonic crystals. Furthermore, it should be noted that a wavelength of the light emitted from light source 214 may be varied depending on a parameter to be sensed. Sensor interface 208 may further include logic circuitry, which encompasses any suitable circuitry and processing equipment necessary to perform operations including receiving and/or analyzing the return signals (reflected light) from the one or more photonic crystals.

Photonic optical sensor 210 may be in communication with detector 216 whereby the detector 216 analyzes an output of the optical sensor 210. Detector 216 may further be connected to the processor 204 for processing.

An example of a device that may be used as the detector 216 is an LEOI-100 Experimental CCD Spectrometer. This spectrometer may be used to analyze the wavelengths of light returned, i.e., the transformed light from the photonic optical sensor 210. By comparing the wavelength of light detected from a photonic optical sensor on a workpiece under operational conditions to a reference wavelength returned from a reference photonic optical sensor, which has a known or no stress, a correlation between strain and a shift in wavelength may be determined. For example, the reference photonic optical sensor may be at or near the surface of the work piece being investigated or observed.

Information on 2-D deformation may also be obtained by using polarized light through measuring the shift in wavelength in each dimension. Using linearly polarized light, directional dependence may be discerned. Alternatively, circularly polarized light may function by interrogating the entire workpiece or material as there is no directional dependence to the circularly polarized light. For example, the obtained signal may be indicative of the temperature of the workpiece. In turn, using a polarizing maintaining fiber to both project and detect light, linear and circular polarization may be obtained throughout the workpiece.

The spectrometer (detector 216) may be calibrated prior to use and may be achieved using light sources of known wavelengths as the calibration points for a linear calibration. A minimum of two wavelengths are required for a linear calibration. High levels of accuracy may be registered using vapor lamps, including mercury, sodium, hydrogen, and neon. Reasonable accuracy may also be achieved using a laser light. The calibration of light sources will each transmit light within an approximate 200 nm range of interest, e.g., using helium and mercury atomic vapor lamps. The spectrometer (detector 216) may also be calibrated using a monochromator or a combination of a monochromator and both neon and sodium vapor lamps.

The processor 204 of electronics module 200 may be configured to generate a map illustrating a degree of temperature, pressure, or strain exhibited at locations within a workpiece. For example, one or more photonic optical sensors may be configured to determine an indication of a physical parameter (i.e., temperature, pressure, or strain) may be processed by electronics module 200 to generate a 3-D map, such as a gray-scale map or a color-coded map, illustrating the degrees of strain, temperature, or pressure exhibited at locations within a drill bit. Furthermore, electronics module 200 may be configured to generate a color-coded map wherein an x-axis and a y-axis of the color-coded map may indicate a location within a workpiece, such as for example, a drill bit, at which the physical parameter was sensed and an amplitude of the sensed physical parameter may be represented by a color (e.g., blue, green, or yellow). For example, the portion of color-coded map having a darker color may represent a region where the amplitude of a sensed physical parameter is less than the amplitude of the sensed physical parameter at another region represented by portions of color-coded map having a lighter color. A map may then be compared to a finite element analysis (FEA) model of a particular workpiece in order to predict possible workpiece failures with a reasonable certainty.

Although a drill bit was mentioned and described as an example, the workpiece is not limited to such application and may be any material workpiece. In an additional embodiment, for example, the workpiece may be a mechanical component of a drilling system that is under significant stress or strain, or is susceptible to high temperature degradation caused by a drilling operation. The photonic optical sensor system may function as a wellbore logging tool and thereby translate mechanical or thermal properties of a workpiece in real time to a surface operator for management and operation control. The system may measure or monitor one or more operational parameters of the wellbore, wellbore environment, wellbore fluids, or formation (collectively referred to as “wellbore environment”). The system may be designed to measure any one operational parameter at any given depth, or alternatively, when the photonic optical sensor moves up and down in the wellbore, it may transmit the data to a surface station or operator. The photonic optical sensor system may include a plurality of optical or mechanical sensors, including at least one photonic optical sensor, each of which may measure a different operational parameter of interest.

In an embodiment, a fiber optic line, such as optical cable 212, which may couple or provide communication between the photonic optical sensor and a detector or processing unit, may be located within a conduit or secure piping to protect the fiber optic line from harsh environments. The conduit may also protect the fiber optic line from strain that may be induced during the deployment, logging, and recovery operations of the photonic optical sensor system. In such a case, the communication may be the propagation of light originating from a light source on the surface through the fiber optic line that projects the light onto the photonic optical sensor. A portion of the projected light that is transformed by the sensor may then propagate back up to the surface, preferably through the same fiber optic line, to therein be detected and analyzed by the processing unit.

A photonic optical sensor as described may also be used to characterize the geological formation of a borehole. The sensor may provide direct, in-situ measurement of important geological parameters such as rock hardness, bulk modulus, shear modulus, as well as a direct calculation of Poisson's ratio. The information may provide on-site, near real time analysis of the geology, and therefore, improve upon the extraction of desired fluids.

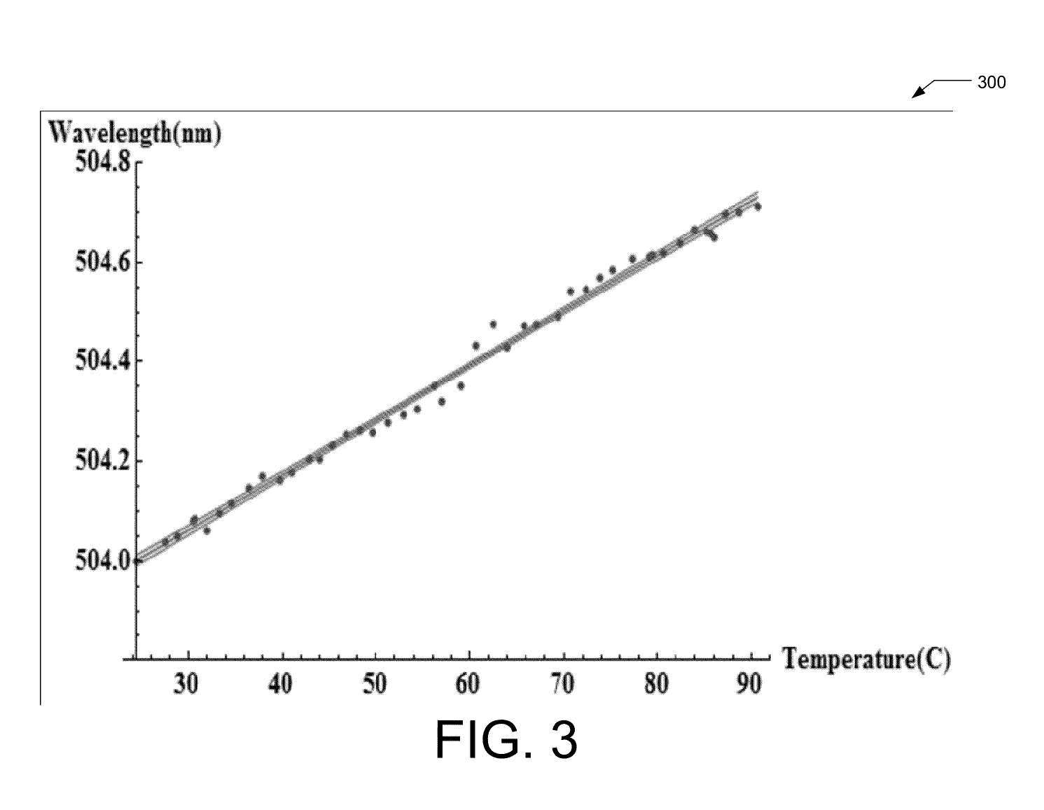

Turning to the other figures, FIG. 3 represents a plot 300 of returned wavelength compared to temperature of a photonic crystal formed in a silicon substrate. To verify results, a thermal couple may be attached to the workpiece to confirm that the photonic crystal may be used as a thermal sensor, for example, in a well logging system. Through an investigation of the shift in wavelength of returned (transformed) light against temperature of the workpiece, there exists a relationship between wavelength and temperature capable of detection.

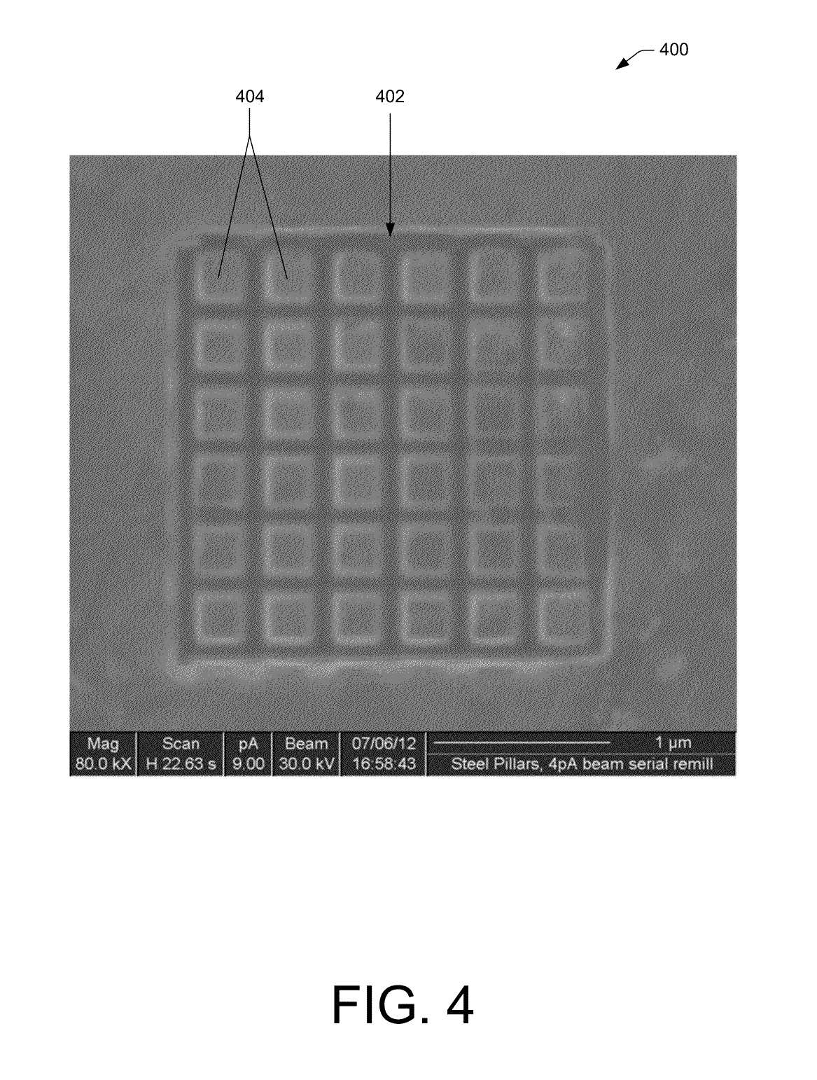

FIG. 4 illustrates a top view microphotograph 400 of an example of a photonic crystal with a 6×6 element lattice 402 of “square-like rods,” which was created via the device and methods described herein. For this example embodiment, a Focus Ion Beam (FIB) machine was used to mill the optical elements 404. The optical elements 404 may best be described as a lattice of square pillars or square-like rods. Note that optical elements formed on workpieces are not limited to the pillared or square-like rods. Rather, the optical elements may be round, square, hexagonal, a log pile, or spheres. Each different shape or structure may have unique advantages, as some shapes may prohibit full band gaps and allow only partial band gaps, thereby resulting in lower resolutions detectable by the detector or other reading devices.

The FIB tool used to create the photonic optical sensor may operate using a beam of accelerated gallium ions to image, etch, or mill a photonic optical sensor onto the workpiece. Note that the optical elements may be formed by alternate methods such as writing or stamping directly onto the workpiece. In an embodiment, the FIB may have a milling resolution of approximately 4 nm to 5 nm. Additionally, the FIB's software may include a scripting language for milling complex shapes. Such implementation may be useful in fabricating large repeating structures such as a photonic crystal because a single lattice unit may only need to be defined. Thereafter, a loop may be used to replicate the lattice unit. Prior MPB simulations of photonic crystals indicated that a honeycomb cell structure may possess the largest complete (TE and TM polarization) band gap. In turn, a script may be written to mill honeycomb features with user defined parameters.

As practical limitations may be placed on the fabrication times of the photonic crystals, investigation may be done on different depth profiles of the crystal elements to determine a minimum depth necessary to produce a photonic crystal that may function as an optical sensor. In an example embodiment, a milling depth of as little as 100 nm may be sufficient to produce an operational photonic crystal. Accordingly, the photonic crystal may have a depth into the material of about 50 nm to about 1000 nm (1 μm), about 50 nm to about 500 nm, or about 50 nm to about 300 nm.

A photonic optical sensor, for example the photonic crystal shown in illustration 400, may include a one-dimensional (1-D) or two-dimensional (2-D) formed on a workpiece. If a 2-D crystal is used as the photonic optical sensor, the 2-D photonic crystal may comprise a sub-micron optical element pattern. If the pattern of optical elements includes a lattice, the photonic crystal may have a minimum of thirty-six optical elements arranged in a 6×6 pattern (See FIG. 4). For example, a 2-D photonic crystal with relatively square rod-like elements may be formed in steel or other materials. If rectangular, a lattice of optical elements may be defined as an element lattice J×K, wherein J and K are independent integers of at least 4, or higher, as there is no upper bound. For example, J may be 4, 5, 6, 7, . . . 30 or more, and for any J, K may be 4, 5, 6, 7, . . . 30 or more. Note, the integers included in the J×K element lattice need not be limited from 4 to 30, but instead, as indicated above, may be any number at least 4 or higher. Integers under 4 may produce a signal to noise ratio that is too low for sensing. Accordingly, integers of 4 or higher may produce a 95% confidence interval of the value being read.

Alternatively, a plurality of 2-D photonic crystals may be fabricated in an array. For example, a 2×2 array (four crystals), a 2×3 array (six crystals), and a 3×3 array (nine crystals). The array may be any geometric arrangement including, rectangular, square, pentagonal, or hexagonal. In an embodiment, if a rectangular geometric arrangement is chosen, the array may be defined as an array M×N, where M and N are independent integers of any number. For example, M may be 1, 2, 3, 4, 5, 6, 7, . . . 30 or more, and for any M, N may be 1, 2, 3, 4, 5, 6, 7, . . . 30 or more. However, the integers included in the M×N element lattice need not be limited from 2 to 30, but instead, may be any integer at least 1 or higher. Under the integer 1, sensing may be limited from the light projected onto the sensor.

In an embodiment, to facilitate the FIB fabrication process (or similar processes) and to reduce fabrication time, a masking layer may alleviate an over-milling problem associated with parallel milling. Parallel milling refers to the simultaneous milling of all features of the photonic crystal simultaneously, and in parallel. Comparatively, serial milling fabricates each feature of the photonic crystal in sequence. Due to time discrepancies in the milling process during parallel milling and the high speed beam blanker associated with FIB milling, parallel milling may occasionally leave the milling beam on over the areas which create the sensor, thereby deteriorating the precision of the milling, and the resolution of the sensor. Application of the masking layer may involve, for example, coating the workpiece before it is positioned in the FIB instrument. In some embodiments, a masking layer may be made of a material resistant to the gas used for etching. In turn, the pattern may be milled onto the workpiece.

The application of the masking layer may resist etching in the workpiece's vein areas where the beam dwell time is shorter. Where the beam dwell time is longer (where the material is porous), the masking layer will be burned through and the material below may be etched. The application of the masking layer may serve to protect the layer below. Therefore, the photonic crystal may be formed on the workpiece or material. The strategic application of the masking layer may therefore prevent the FIB tool from compromising the workpiece or material below the masking layer, as photonic crystals may only be desired in certain locations, for example, areas of high heat flux.

Parallel and serial milling methods may be used to create the photonic crystal according to the instant application that may function as a photonic optical sensor on a workpiece. Parallel milling may produce shorter rods, unless a masking layer is utilized, while serial milling with a re-milling step may be used to alleviate backfill produced square pillars in steel with good definition in both axes. A cross-section on one of a sample sensor was performed in order to observe the depth and aspect ratio of the trenches between pillars. Parallel milling, while producing photonic crystals faster, may result in reduced quality sample sensors. Comparatively, serial milling may provide improved aspect ratio milling.

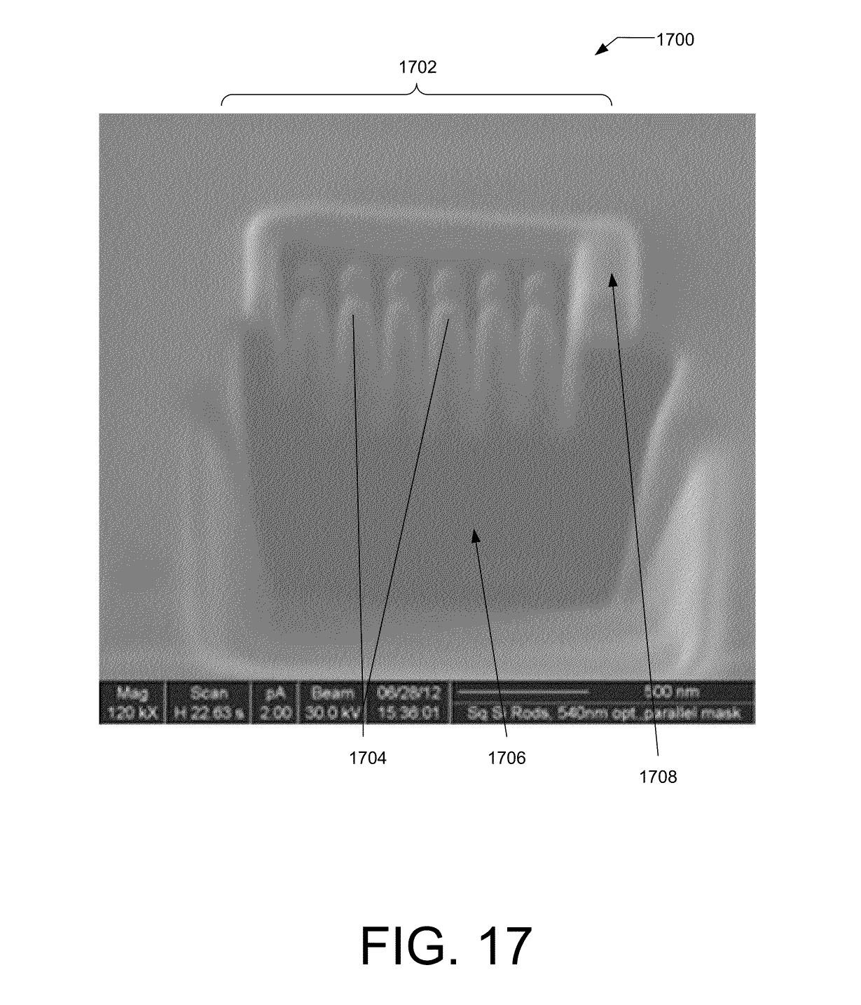

FIG. 17 is an embodiment showing a cross-sectional microphotograph 1700 of a photonic sensor 1702. The photonic sensor 1702 may include pillars 1704 made in bulk material 1706 with masking layer 1708. Examples of masking layers may include using platinum over silicon. In turn, the platinum layer may be fully removed across the full pattern and the silicon rods below may be significantly taller than those generated by a similar parallel etch without the platinum layer.

To optimize the photonic optical sensor, the photonic crystal etched into the workpiece may be specifically designed to operate within a given materials, or workpiece's properties, a given wavelength of light, and to respond to the projected light in a predictable fashion as to render a precise response.

Alternatively, other fabrication methods that may be used to form a photonic crystal onto the workpiece. Alternate process include processes such as spin-coating, forming mask layers, and reactive ion etching (RIE). Using RIE, a substrate such as steel, may be coated with a thick layer of masking material. Thereafter, a second masking layer may be applied. The second masking layer may then be etched in the appropriate pattern consistent with the photonic crystals. The RIE may then selectively etch through the second masking layer to pattern the first applied masking material. A second RIE, of different chemistry, may then etch the substrate through the first applied masking material and onto the workpiece.

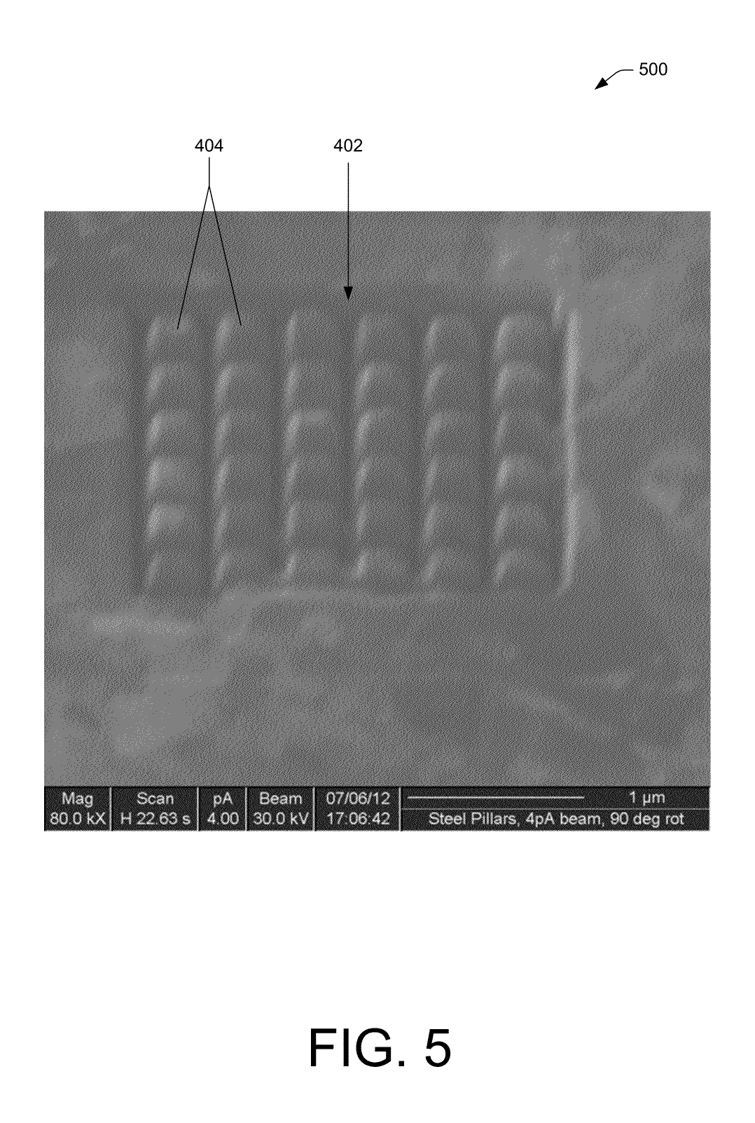

FIG. 5 is a microphotograph 500 of the 6×6 element lattice as depicted in FIG. 4 when viewed at a 45° angle. Depending on the information sought, or to optimize the intensity of the transformed light, it may be useful to project the light onto the photonic optical sensor at an angle of from about 30° to about 80° on an axis perpendicular to a face of the photonic optical sensor. In an embodiment, projecting light at an angle onto the optical elements 404 of the photonic crystal 402 may be implemented when no tangential access to the workpiece exists, for example, if there is a moving fan rotor or an impeller blade. Consequentially, the projection of the light source at an angle may allow for further application of the photonic optical sensor. In applications when projected at an angle is infeasible, it may be possible to implement time gating, whereby the processing unit may read the moving objects, for example the fan rotor or impeller blade, such that characteristics desired to be measured may be obtained.

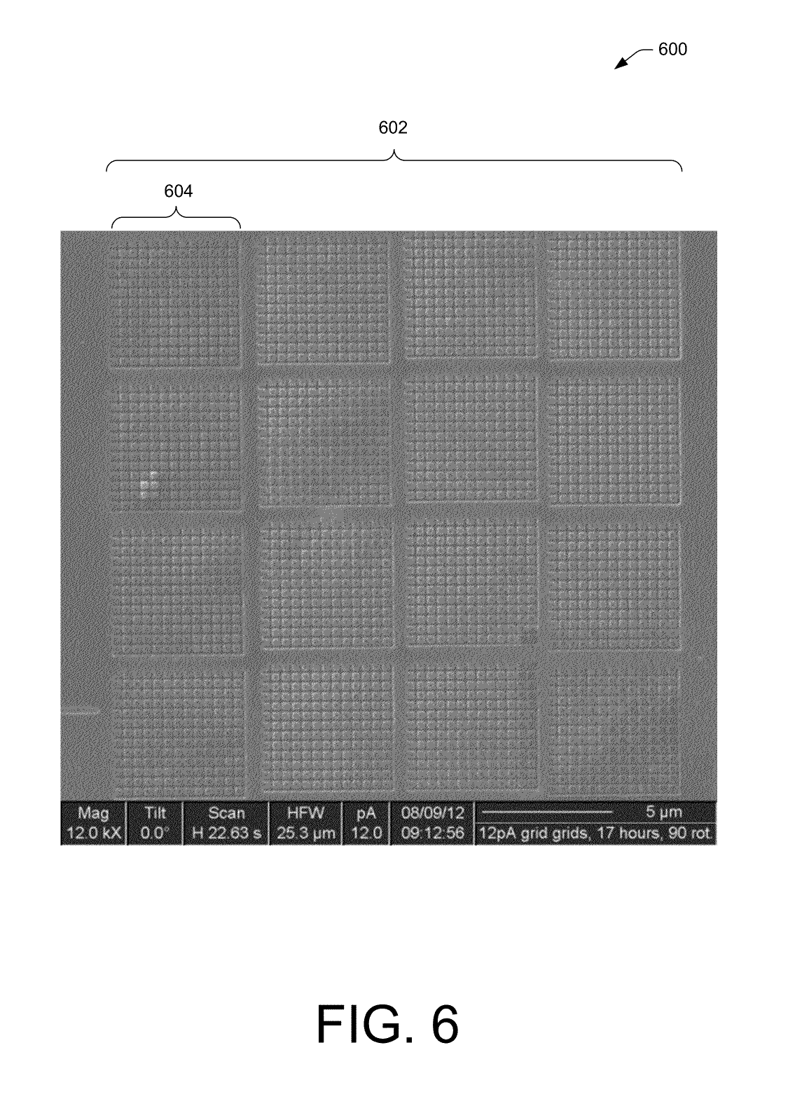

As shown in FIG. 6, a microphotograph 600 of a 4x4 photonic crystal array 602 with 16 crystals 604, each approximately 5 μm², etched into steel. Using a 12 pA aperture, fabrication of the 4×4 photonic crystal array 602 required an approximate run time of 17 hours, equating to a milling rate of approximately 2.5 minutes per square micron of crystal to form a lattice of square-like rods. Using the FIB, photonic crystals up to approximately 30 μm on a side of the rod may be fabricated in approximately 50 hours.

Using a digital optical microscope system, the 4x4 photonic crystal array 602 may be examined at high optical magnification to determine the optical properties of the array. So as to not limit the instant application, photonic crystal of different arrays may be examined as well. However, signal noise obtained using the sensor increases with larger arrays.

The microscope system may be equipped with a 10 megapixel CMOS camera for recording optical microphotographs. In an embodiment, as photonic crystals may be designed for incident light perpendicular to the axis of the optical elements, it may be necessary to use side lighting to observe any photonic optical effect. Incident light perpendicular to the axis may be more suitable for 1-D crystals, as such application may improve the signal to noise ratio. However, side lighting is compatible and may be used in 2-D sensor applications.

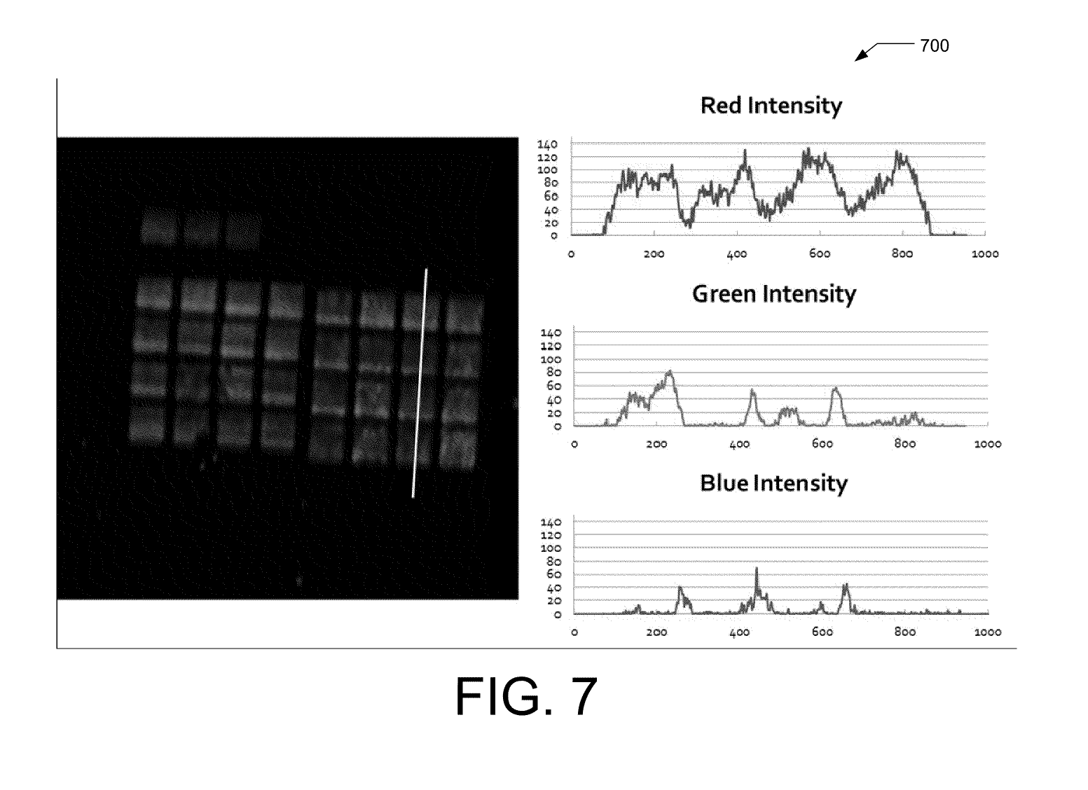

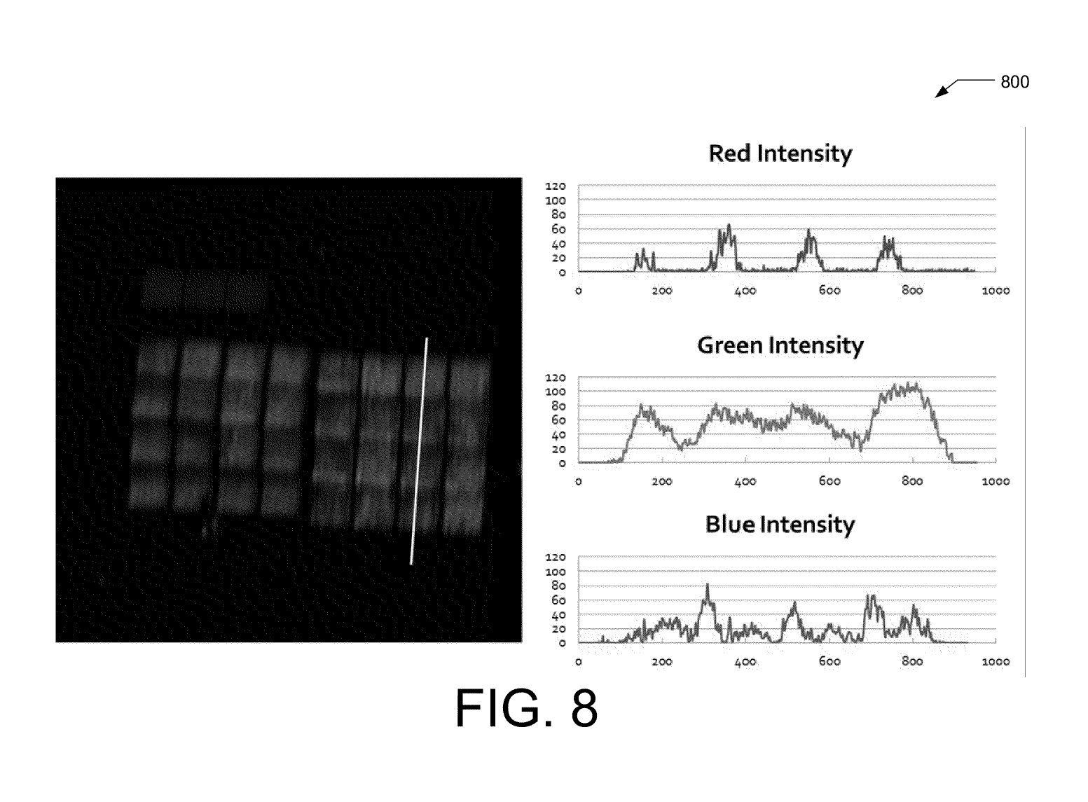

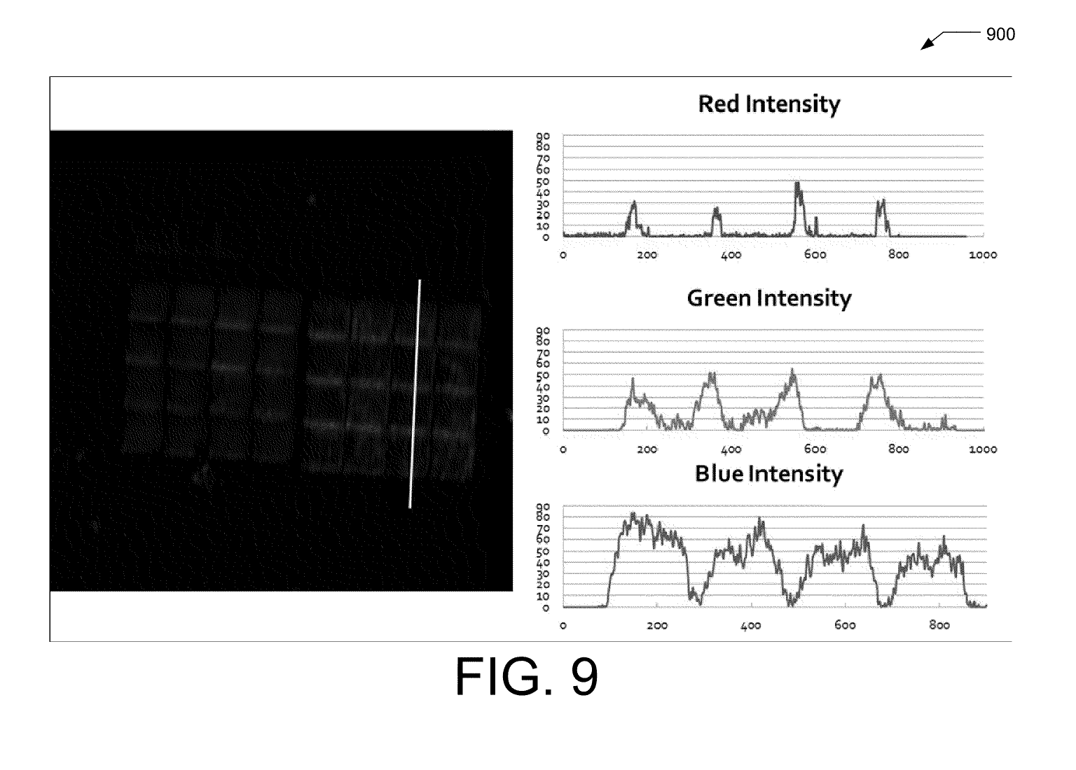

FIGS. 7, 8, and 9 are micrographs 700, 800, and 900, respectively, showing the 4×4 photonic crystal array 602 of FIG. 6 under various side-lighting conditions. In each of FIGS. 7, 8, and 9, the white line represents the location of a line intensity scan broken into the three color channels. In some embodiments, using different color channels may produce higher order harmonics that may have shorter wavelengths. Additionally, different color channels create longer wavelengths on length scales, thereby forming different color bands. As the angle of incident light is modified, the returned wavelength from the 4x4 photonic crystal array 602 changes accordingly. In reference to the micrographs of FIGS. 7, 8, and 9, the un-machined surface appears black as the incoming light is at a steep angle and reflected into the lens of the optical microscope.

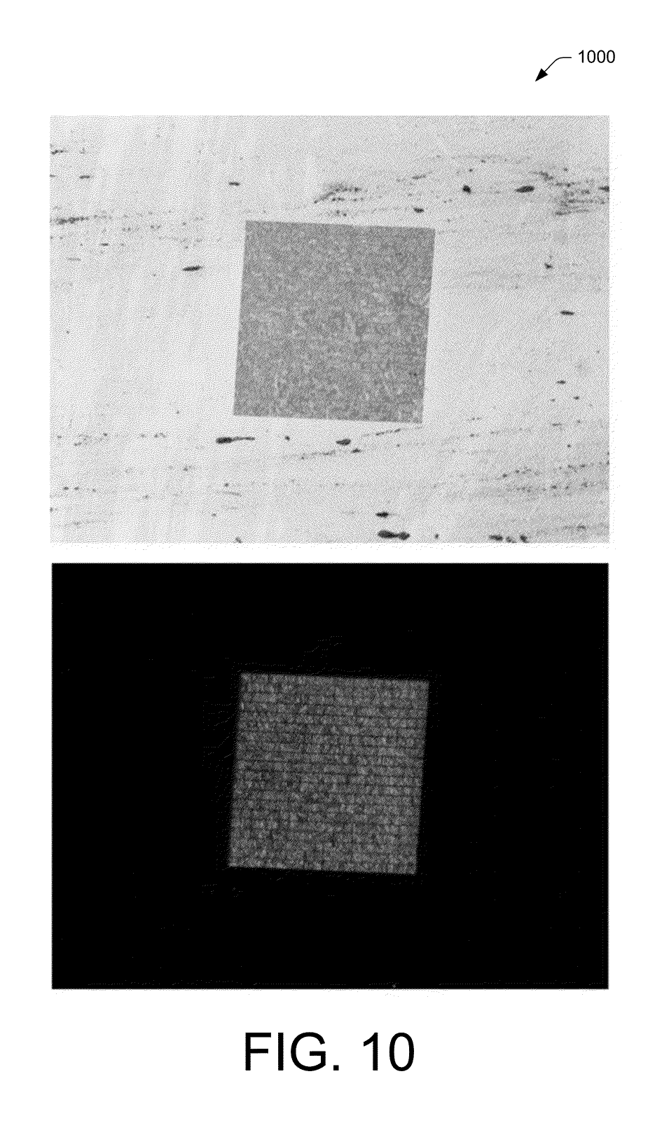

As shown in image 1000 of FIG. 10, an FEI DualBeam FIB machine may produce a 150×150 μm Bragg grating in steel in an approximate mill time of 21 hours. Continued experimentation with larger beam currents for milling with the DualBeam system demonstrated that a photonic optical effect may be observed in 2-D crystals produced with a 300 pA beam. In an embodiment, producing photonic arrays at this beam current may provide for the production of large arrays of photonic optical crystals. For example, a 2×2 array of 15×15 square rod photonic crystals (each 5 μm on edge) may be of sufficient size to be visible without optical magnification.

Alternatively, a 1-D Bragg grating (a 1-D photonic crystal) may require only a set of parallel lines milled into a workpiece or material. In contrast to 2-D photonic crystals, a 1-D Bragg grating may be milled in less time and have a larger area. For example, one may fabricate a 1-D Bragg grating in industrial steel that has a minimum feature area of about 50 μm×50 μm, or about 2500 μm² or greater. In an embodiment, larger 1-D Bragg gratings may provide higher signal response intensities. Exemplary 1-D Bragg grating may have a feature area of about 6000 μm² or greater, about 16,000 μm² or greater, or about 30,000 μm² or greater. In a further embodiment, a typical feature area for a 1-D Bragg grating may be from about 8,000 μm² to about 60,000 μm².

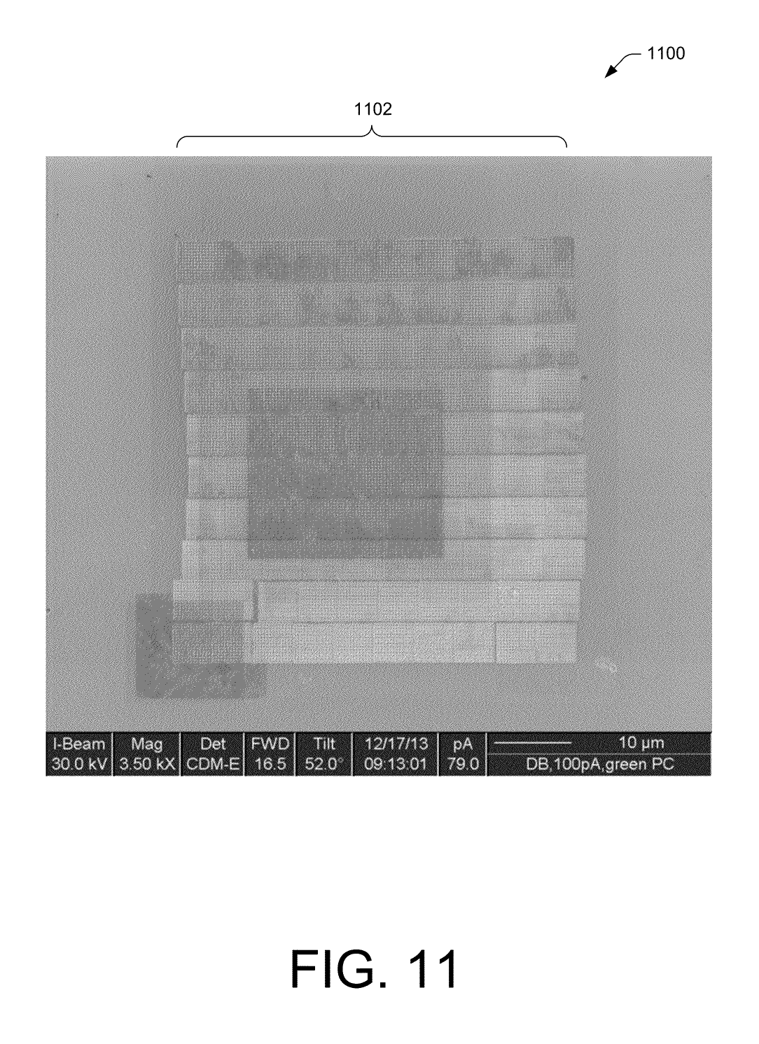

In FIG. 11, a microphotograph 1100 is shown of a 10×10 photonic crystal array 1102 of 5 μm photonic crystals formed in steel produced and subjected to photonic interrogation with a CCD spectrophotometer. Side lighting was thereafter provided with a halogen bulb having a flexible light pipe style microscope illuminator. In an embodiment, before measurement, the incident angle of light may be manipulated to give a strong green return.

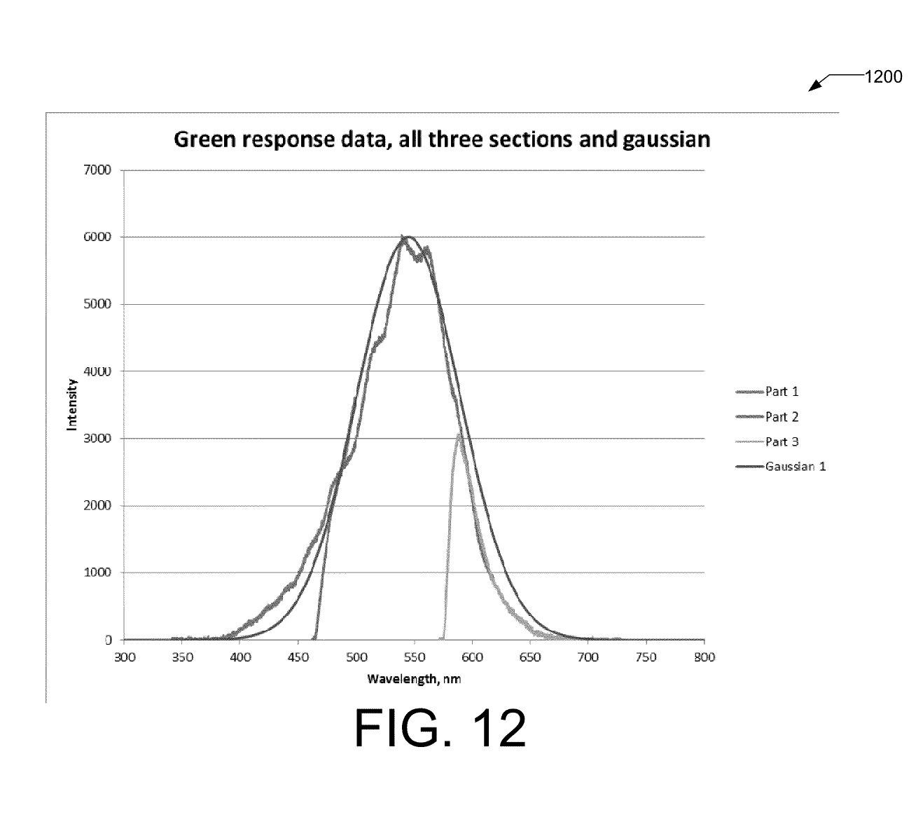

Three different measurements centered at 420 nm, 540 nm, and 650 nm, and a reference workpiece (steel without a milled crystal) may be taken, from which the return light at each wavelength range is measured and subtracted against (therein to be used as a reference). Corresponding to FIG. 11, the resulting returned light is shown in graph 1200 of FIG. 12. Analysis of the returned light from the array shows that the centroid of a peak is in the vicinity of 540 nm (green) and the full width half maximum of this peak is approximately 100 nm.

FIG. 12 further illustrates the collected data 1200 plotted against a Gaussian curve with the centroid at 545 nm and Full Width at Half Maximum (FWHM) of 105 nm. MPB simulations indicated that an ideal photonic optical device of this design on pure iron may yield a peak with a centroid at 540 nm and a band gap width of approximately 50 nm.

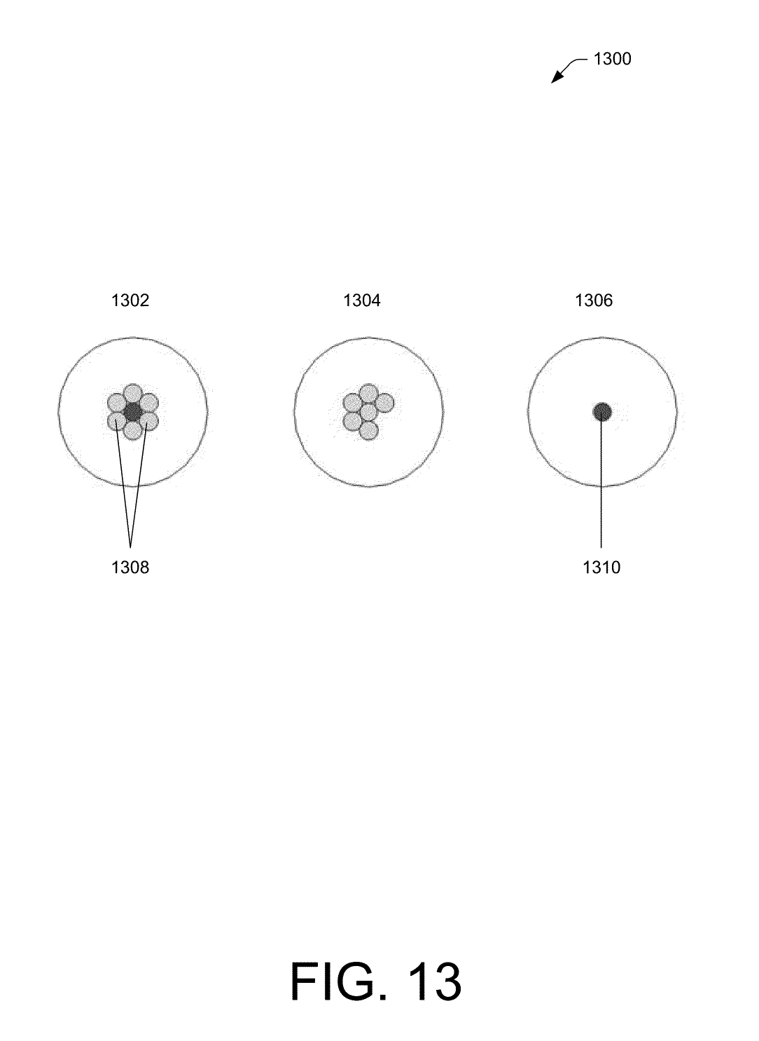

In an embodiment of the photonic optical sensor, FIG. 13 illustrates an embodiment 1300 where the returned light from the Bragg grating (1-D photonic crystal) may be strongest because the light source and detector are on the same horizontal axis. The embodiment 1300 may include a sample end 1302, a light source end 1304, and a spectrometer end 1306. For example, embodiment 1300 may be a grouping of fiber optic cables used to measure the return light from the photonic crystal and may include a plurality of individual fibers. In an embodiment, outer fibers 1308 may be used to carry the light to be projected on the photonic crystal while an inner center fiber 1310 may be used to carry the returned light. The spectrometer end 1306 may include a single SMA connector, projection fibers, and furthermore, return fibers may include a separate SMA connector at the other end of the bundle. This described embodiment may allow for light to be projected whereby the returned light may be examined along the same line and may give the strongest return for a 1-D crystal, enabling high resolution yields and accurate readings.

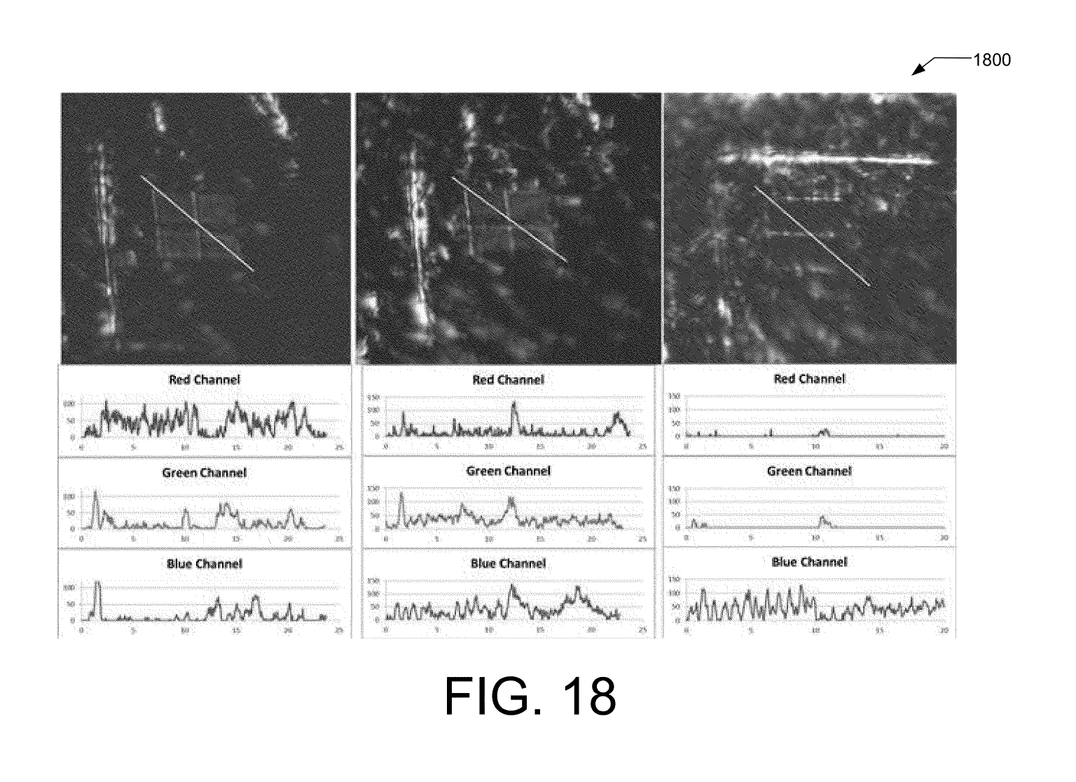

Correspondingly, as shown in microphotograph 1800 of FIG. 18, the same examination may be conducted on a 2-D crystal.

As previously indicated, in the case of a 2-D photonic crystal, it may be useful to use a polarized light source to indicate directional force components of a workpiece material under stress. In addition, by using different polarizations of incident light, data on stress states in multiple axes and 3D changes may be acquired for the workpiece.

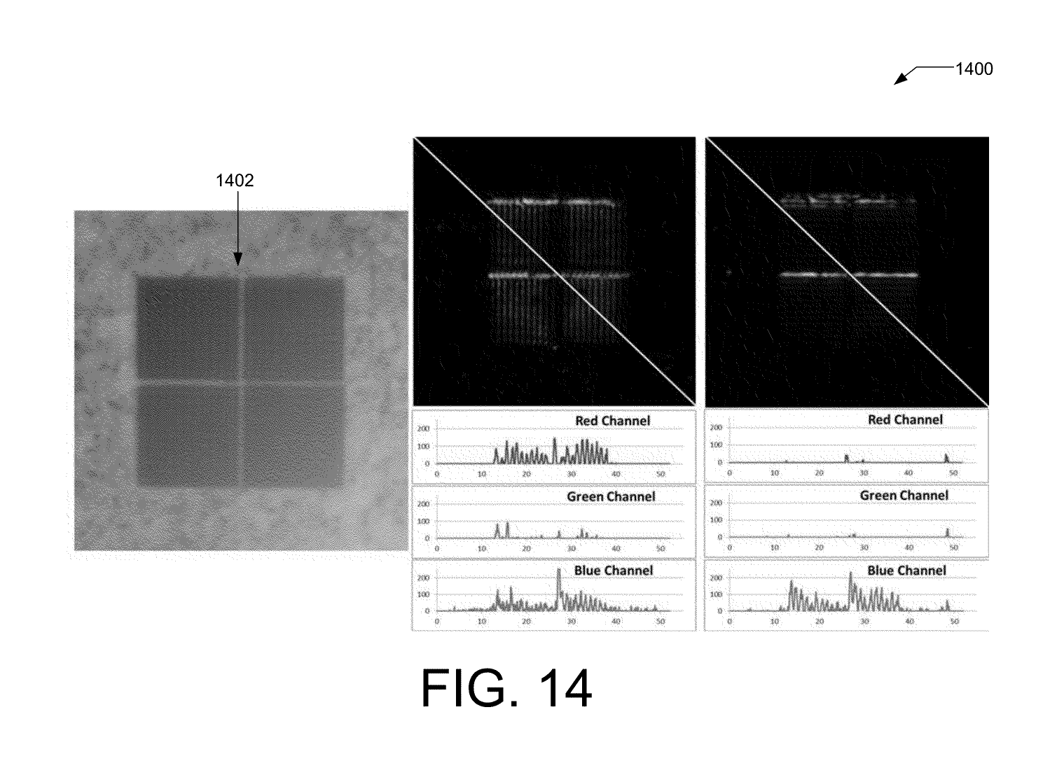

FIG. 14 illustrates color micrographs 1400 of a Zircaloy-4 material with a 2-D 2×2 photonic crystal array 1402. The 2-D 2×2 photonic crystal array 1402 in Zircaloy-4 was milled using the above described FIB process, and the photonic optical affects were examined with optical microscopy. In an embodiment, parameters of Zircaloy may be somewhat different than steel because of Zircaloy's lower real index of refraction. However, MPB simulations indicated that it may possible to produce photonic crystals on Zircaloy. In turn, a photonic crystal array was optimized for bands in the red and blue range, and the collected light data showed strong red and blue returns.

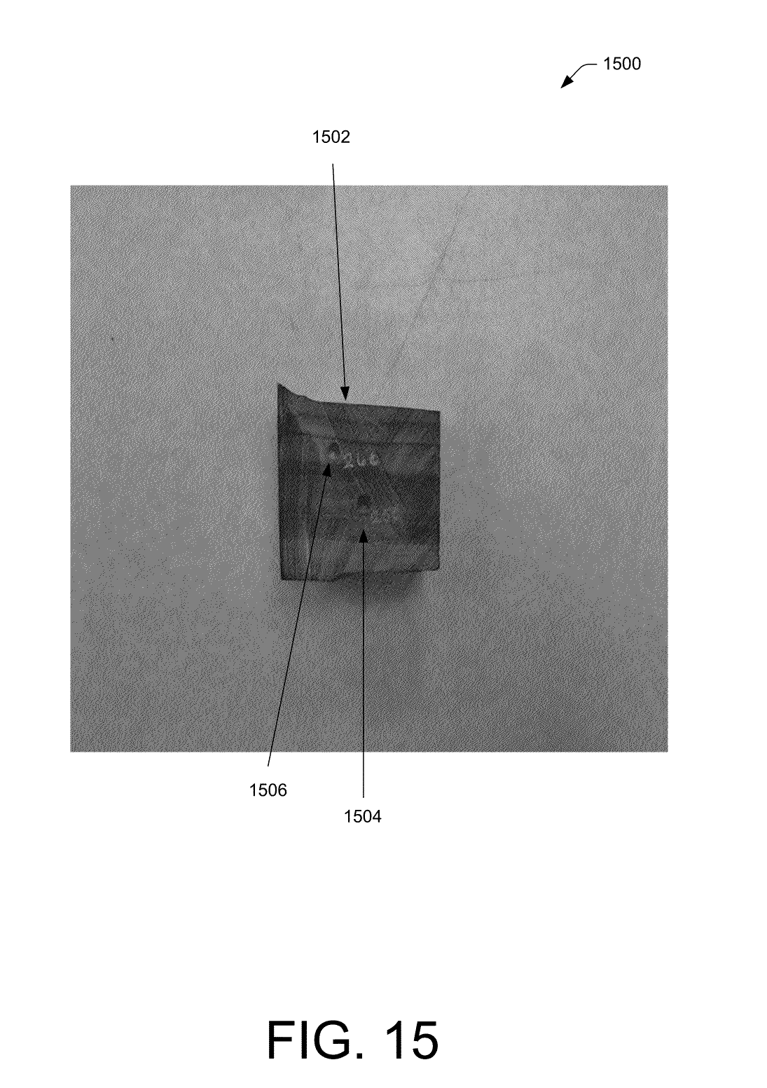

FIG. 15 illustrates is a photograph 1500 of a sample shale 1502 characterized using a mechanical indenter apparatus equipped with a photonic optical sensor at two different pressures, 1504 and 1506.

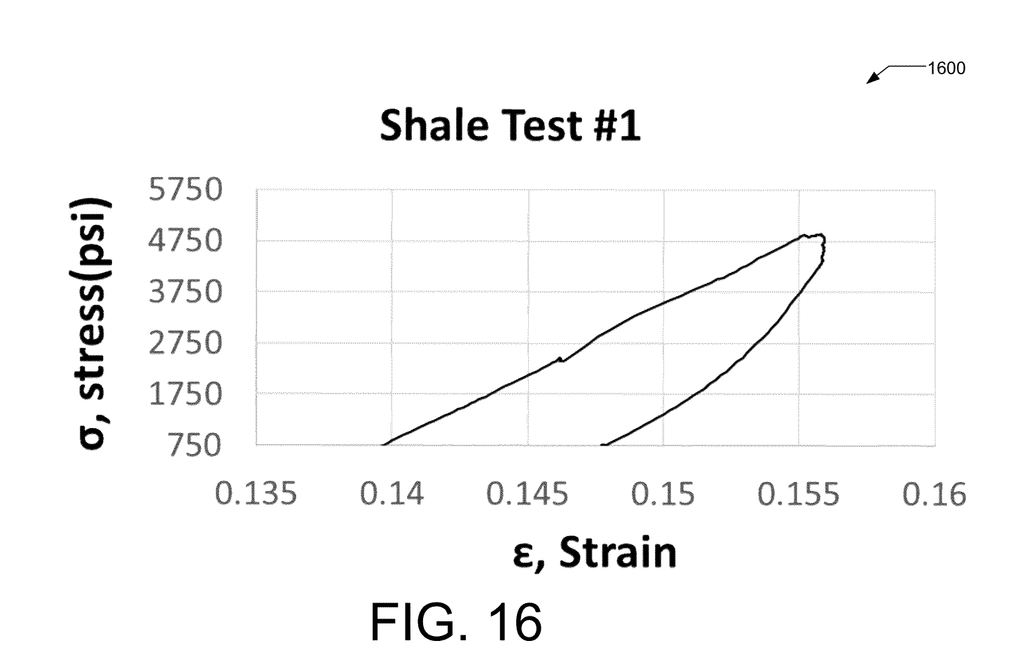

FIG. 16 shows the experimental stress/strain plot 1600 of the shale sample in FIG. 15, as determined from an indenter with a photonic optical sensor according to the instant application.

In an example workpiece embodiment, it may be advantageous to measure physical conditions of a drill bit within a downhole environment using one or more photonic crystal sensors as such technology is rugged, reliable, and relatively inexpensive to manufacture and operate. Moreover, the photonic crystals have no downhole electronics or moving parts, and therefore, may be exposed to harsh operating conditions without the typical loss of performance exhibited by common electronic and solid state sensors.

### Conclusion

Although several embodiments have been described in language specific to structural features and/or methodological acts, it is to be understood that the claims are not necessarily limited to the specific features or acts described. Rather, the specific features and acts are disclosed as illustrative forms of implementing the claimed subject matter.

What is claimed is:

1. A system comprising:
a photonic optical sensor including a photonic crystal;
an incident light source arranged to project light onto the photonic optical sensor such that the photonic optical sensor returns a portion of the light projected thereon as returned light;
a detector positioned with respect to the photonic optical sensor so as to detect the returned light, and the detector producing a data output based on the returned light; and
a processing unit that processes the data output.

2. The system of claim 1, wherein the photonic optical sensor is formed on or in a workpiece for the detection of at least one of a thermal property or a mechanical property of the workpiece.

3. The system of claim 2, further comprising:
a reference photonic optical sensor formed on the workpiece at a location with a known reference mechanical property.

4. The system of claim 1, wherein the photonic optical sensor includes a 1-D photonic crystal.

5. The system of claim 4, wherein the photonic crystal has a minimum feature area of 2500 nm².

6. The system of claim 1, wherein the photonic optical sensor includes a 2-D photonic crystal.

7. The system of claim 1, wherein the photonic crystal includes a sub-micron optical element pattern.

8. The system of claim 7, wherein the sub-micron optical element pattern includes a lattice having a minimum of 1 element.

9. The system of claim 7, wherein the sub-micron optical element pattern has a minimum optical element area of 2500 nm².

10. The system of claim 1, wherein the incident light source is polarized.

11. The system of claim 1, wherein the incident light source is projected at an angle of about 30° to about 80° at an axis perpendicular to a direction of extension of the photonic optical sensor.

12. The system of claim 1, wherein the detector is a CCD spectrophotometer.

13. The system of claim 1, wherein the data output transfers from the detector to the processing unit via an optical fiber.

14. The system of claim 13, wherein the optical fiber includes at least one optical fiber of a plurality of optical fibers via which the incident light source and the returned light transmit along a same axis.

15. A method, comprising:
applying a masking layer onto a workpiece; and
forming a photonic crystal onto the workpiece in the masking layer.

16. The method of claim 15, wherein the photonic crystal is a first photonic crystal as a first photonic optical sensor, and
wherein the method further comprises forming a second photonic crystal onto the workpiece as a second photonic optical sensor for a reference comparison to the first photonic optical sensor.

17. The method of claim 15, wherein the first photonic optical sensor is formed on a material including at least one of a metal, metal alloy, ceramic, plastic, or composite material.

18. The method of claim 15, wherein the first photonic optical sensor includes a at least one of a 1-D or a 2-D photonic crystal.

19. The method of claim 15, wherein the forming the photonic crystal includes etching via a focused ion beam mill.

20. The method of claim 15, wherein the forming the photonic crystal includes forming via a reactive ion exchange etching process.

21. The method of claim 15, wherein the forming the photonic crystal includes etching a lattice unit to form a photonic optical sensor.

22. The method of claim 15, wherein the applying the masking layer includes applying a plurality of masking layers to the workpiece, and
wherein the forming the photonic crystal includes forming the photonic crystal through a first masking layer of the plurality of masking layers and into a second masking layer beneath the first masking layer and on the workpiece.

23. The method of claim 22, wherein at least one of the plurality of the masking layers is resistant to a gas used in forming the photonic crystal.

24. The method of claim 15, further comprising measuring a thermal property of the workpiece via the photonic crystal.

25. The method of claim 15, further comprising measuring at least one of a thermal property or a mechanical property of the workpiece via the photonic crystal.

26. A method of measuring and detecting a mechanical property, comprising:
forming a photonic optical sensor onto a workpiece;
projecting a light source onto the photonic optical sensor; and
detecting returned light from the photonic optical sensor.

27. The method of claim 26, further comprising:
forming a reference photonic optical sensor onto the workpiece; and
comparing a wavelength of the returned light from the workpiece under operational conditions with a known wavelength of returned light projected onto the reference photonic optical sensor.

28. The method of claim 27, further comprising, determining at least one of a thermal property or a mechanical property of the workpiece based on an output from the detecting of the returned light.
